(19) United States
(12) Patent Application Publication
(10) Pub. No.: US 2003/0079152 A1
(43) Pub. Date: Apr. 24, 2003

(54) Microprocessor with multiple low power modes and emulation apparatus for said microprocessor

(76) Inventor: Joseph W. Triece, Phoenix, AZ (US)

Correspondence Address: BAKER BOTTS, LLP, 910 LOUISIANA, HOUSTON, TX, 77002-4995, US

(21) Appl. No.: 09/929,622

(22) Filed: Aug. 14, 2001

(51) Int. Cl. G06F 1/26; G06F 1/28; G06F 1/30

(52) U.S. Cl. 713/322

(57) ABSTRACT

A microprocessor comprises a central processing unit receiving a first clock signal, a plurality of peripherals receiving a second clock signal a first select unit for selecting the first clock signal out of a plurality of clock signals and a second select unit for selecting the second clock signal out of the plurality of clock signals. The central processing unit comprises an execution unit which controls the select units upon execution of a low power mode instruction to select a clock signal for the central processing unit and the peripheral units.

### FIELD OF THE INVENTION

The present application relates generally to microprocessors having the capability of operating in a low power mode, in particular to an arrangement and a method within a microcontroller or microprocessor for controlling the power consumption. Furthermore, the present application relates to a method and apparatus for emulating a microprocessor comprising such low power modes.

### BACKGROUND OF THE INVENTION

Microprocessors, in particular microcontrollers are used in many applications using an independent power source, such as a battery. To extent battery life many microprocessors provide specific measurements to save energy. For example, many microprocessors have the ability to run at different clock speeds. Therefore, a special unit provides a plurality of system clocks which can be connected with the clock input of a microprocessor core. Furthermore, in completely static embodiments of a microprocessor the system clock can be shut off completely to preserve even more battery life. However, low power modes known in the art are not flexible enough for many applications with microprocessors using a battery as their main power source.

### SUMMARY OF THE INVENTION

Therefore, the present application discloses exemplary embodiments which overcome the above mentioned problems as well as other shortcomings and deficiencies of existing technologies.

In a first exemplary embodiment a microprocessor comprises a central processing unit receiving a first clock signal, a plurality of peripherals receiving a second clock signal a first select unit for selecting the first clock signal out of a plurality of clock signals and a second select unit for selecting the second clock signal out of the plurality of clock signals. The central processing unit comprises an execution unit which controls the select units upon execution of a low power mode instruction to select a clock signal for the central processing unit and the peripheral units.

Another embodiment of a microprocessor further comprises in addition a low power mode register for determination of a low power mode being coupled with the select units. Yet another improvement comprises a mask register coupled with the low power mode register for limiting access to the low power mode register.

The select units can comprise a multiplexer coupled with the low power mode register for controlling a select switch control unit controlling a select switch receiving the plurality of clock signals. Yet another embodiment comprises a synchronizer unit for synchronizing switching of the clock signals. Another embodiment comprises a decoder logic coupled with the low power mode register for controlling a select switch control unit controlling a select switch receiving the plurality of clock signals.

The plurality of clock signals can be generated by internal, external, or partly internal oscillator unit. Furthermore, in another exemplary embodiment a programmable divider unit can be used to provide a variety of clock signals. An oscillator unit can be a low power oscillator having a lower frequency than the system clock oscillator.

In yet another exemplary embodiment the microprocessor further comprises a watchdog timer which generates a control signal fed to the select units for setting a default clock.

A system comprising one or more of the above features provides a highly improved flexibility with respect to improving the efficiency and versatility of using different power modes. For example, in many applications peripheral units have to be fully operational while the central processing unit may completely shut down. The present embodiments can be easily expanded to multiple select units so different peripherals can receive different clock signals according to their respective specification.

Yet another embodiment shows a microprocessor emulation unit comprising a first microprocessor comprising: a central processing unit receiving a first clock signal and generating a low power mode signal upon execution of a low power instruction. Furthermore, a first select unit is provided for selecting the first clock signal out of a plurality of clock signals and a first register is coupled with the select unit for storing a low power mode value. An execution unit within the central processing unit is provided which controls the select units upon execution of a low power mode instruction. The microprocessor emulation unit further comprises a second microprocessor with deactivated central processing unit and plurality of peripherals receiving a second clock signal. Furthermore, a second select unit is provided for selecting the second clock signal out of the plurality of clock signals and a second register is coupled with the select unit for storing a low power mode value. First and second register are coupled in a way that both registers are written at the same time. A control unit receives the low power mode signal for transferring the data of the first register into the second register and for controlling the second select unit.

A method of setting clock signals for a central processing unit and at least one peripheral unit within a microcontroller arrangement, comprises the steps of:

selecting a first and second clock value;

executing a low power instruction;

coupling said first clock signal with the central processing unit; and

coupling said second clock signal with the peripheral unit.

Another method of emulating a microcontroller having a plurality of low power modes, comprising the steps of:

providing a microprocessor having a first low power mode register;

providing a microcontroller having a second low power mode register;

deactivating a central processing unit of the microcontroller and coupling the microprocessor and the microcontroller to form a single microcontroller;

upon execution of a low power mode instruction within the microprocessor coupling a clock signal with the microprocessor according to the low power mode register content and coupling a clock signal with the microcontroller according to the low power mode register content.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 shows a block diagram of an exemplary embodiment showing a microcontroller according to the present invention;

FIG. 2 depicts an exemplary embodiment showing the clock select unit for the microprocessor core in more detail;

FIG. 3A is an exemplary embodiment of a clock select unit for peripherals according to FIG. 1;

FIG. 3B shows an embodiment of a synchronizer circuit for the select units shown in FIGS. 2 and 3A;

FIG. 3C shows an oscillator arrangement for generating multiple clock signals.

FIG. 4 depicts another exemplary embodiment according to the present invention;

FIG. 5 is a state diagram showing different power safe modes according to the present invention;

FIG. 6 shows flow chart of another embodiment according to the present invention; and

FIG. 7 is a block diagram of an emulator coupled with a microcontroller header board according to the present application.

### DETAILED DESCRIPTION OF THE PREFERRED EMBODIMENTS

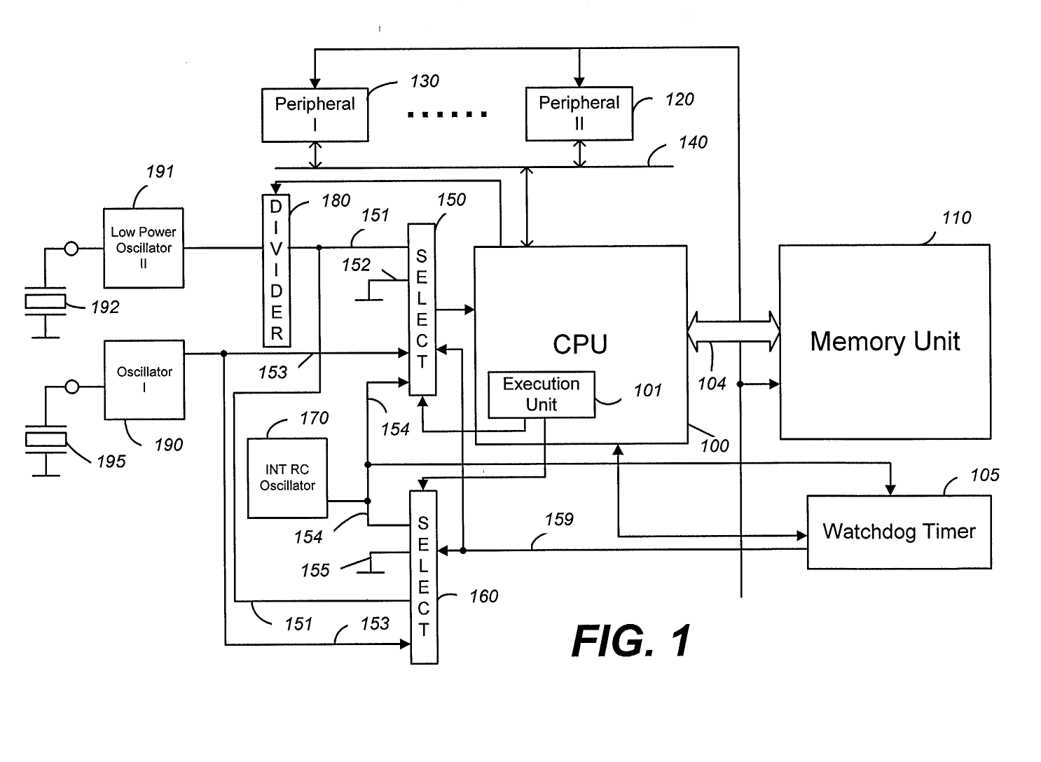

Turning to the drawings, exemplary embodiments of the present application will now be described. In FIG. 1, numeral 100 shows a central processing unit of a microprocessor or microcontroller. Central processing unit 100 is coupled via a bus 104 with a memory unit 110. For coupling the central processing unit 100 with multiple peripheral units a bus 140 is provided. Central processing unit 100 is coupled through this bus 140 with a plurality of peripheral units 120 . . . 130. A first select unit 150 is provided which outputs a clock signal which is fed to the system clock input of central processing unit 100. Four different input signals are fed to select unit 150. A first oscillator unit 190 generates a main system clock 153 which is fed to one of the select inputs of select unit 150. Another input 152 is directly coupled with ground. A low power oscillator unit 191 generates another clock signal which is fed to a programmable divider unit 180. The output 151 of programmable divider unit 180 is coupled with a third input of select unit 150. Central processing unit 100 generates a control signal which controls divider unit 180. Oscillator unit 190 and low power oscillator unit 191 are each coupled with an external crystal 192 and 195, respectively. Another internal RC-oscillator unit 170 is completely integrated and generates an output signal 154 which is fed to the fourth input of select unit 150. Internal RC-oscillator 170 does not need any external component. Central processing unit 100 comprises an execution unit 101 which generates a control signal which controls select unit 150. Execution unit 101 executes instructions stored as a program sequence in memory unit 110. A second select unit 160 is also controlled by central processing unit 100 through the execution unit 101. Second select unit 160 receives the different clock signals 151, 153, and 154. A fourth input 155 is coupled directly with ground. The output signal of select unit 160 is coupled with the clock inputs of peripheral units 120 . . . 130. If memory unit 110 also needs a system clock the respective clock input is also coupled with the output of select unit 160. Furthermore a watchdog timer 105 is provided which is coupled with central processing unit 100. The watchdog timer 105 receives a clock signal from the internal RC oscillator 170. Watchdog timer 105 generates a control signal which is fed to select units 150 and 160.

The present exemplary embodiment operates as follows. Normal mode is usually selected after a reset as the default mode. A reset unit (not shown) or a reset signal from central processing unit 100 generates a respective control signal which is sent to select units 150 and 160 to select the system clock 153 generated by oscillator unit 190. Furthermore, watchdog timer 105 can generate an override signal 159 which has the same effect as a reset and can be used as a wake-up signal to select normal operating mode. The override signal 159 also selects the system clock 153. Therefore, in normal mode select unit 150 couples this signal 153 with the clock input terminal of central processing unit 100. Furthermore, in normal operating mode, select unit 160 selects also the system clock 153 for distribution to all peripheral units 120 . . . 130 and memory unit 110 if this unit needs a clock signal. A plurality of low power modes are provided in which the central processing unit 100 controls select units 150 and 160 to select one of the four input clocks for distribution to the central processing unit and the peripheral units, respectively. Thus, different clock signals with different clock frequencies can be distributed separately to the central processing unit and the peripheral units.

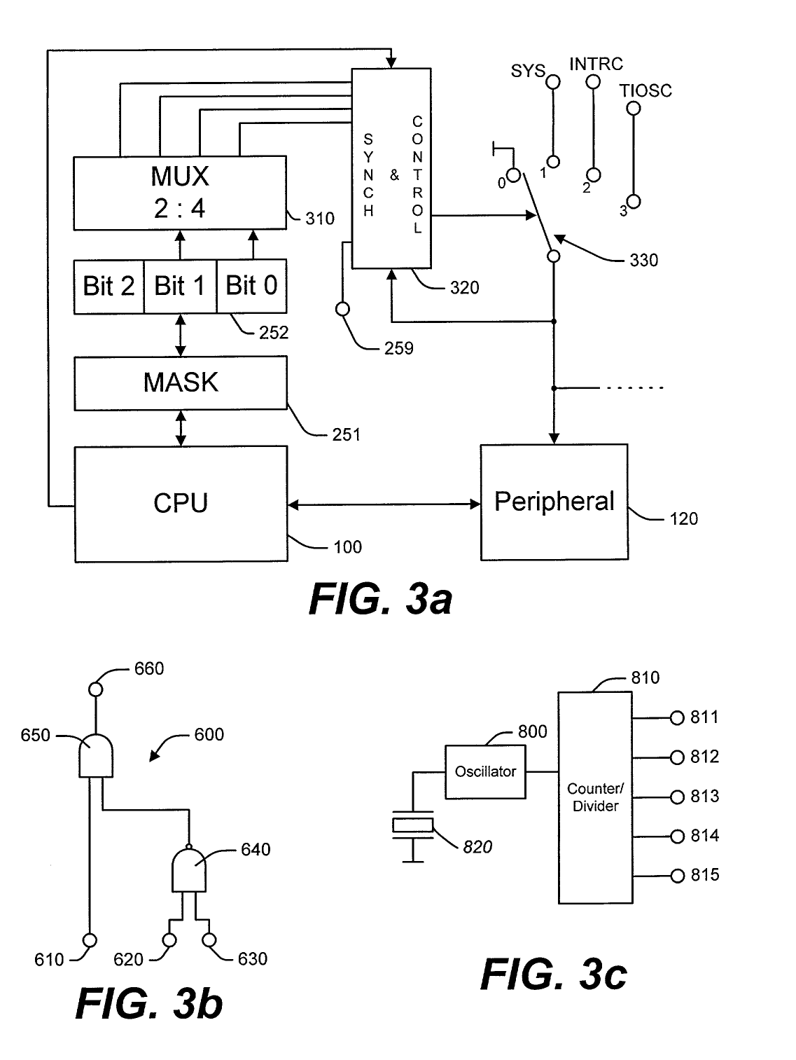

In another embodiment a single oscillator unit can be used to provide a plurality of clock signals, for example by means of a counter or divider unit with multiple outputs. Such an arrangement is shown in FIG. 3C. An oscillator 800 is externally coupled with a crystal 820. The output of oscillator 800 is fed to a counter/divider unit 810 which comprises a plurality of outputs 811, 812, 813, 814, and 815. Each output 811, 812, 813, 814, and 815 represents a different bit of a counter. Thus, for example, output 815 carries output frequency f of oscillator unit 800, output 814 carries f/2, output 813 carries f/4, output 812 carries f/8, and output 811 carries f/16. The switching from one mode to another mode will be explained later. As mentioned above, all peripheral units 120 . . . 130, memory unit 110 and central processing unit 100 comprise a static design. Thus, ground signal 152 can be selected as a system clock which in turn stops central processing unit 100 and/or all peripheral units 120 . . . 130, and memory unit 110 which are coupled with select unit 160 or 150, respectively. In this shut off mode only watchdog timer 105 remains active. Furthermore, central processing unit 100 might comprise the necessary circuits to uphold the respective control signals for select units 150 and 160 so that their respective status is maintained. Of course select units 150 and 160 can provide respective circuitry to maintain their status as long as central processing unit 100 receives no clock signal.

In addition to certain clock selections a predefined list of peripherals can be completely shut of to preserve more energy. For example, if low power oscillator unit is selected for both, the central processing unit and the peripherals, then all other oscillator units can be switched off completely. Some peripherals might not be functional with certain clock signals and therefore can also be cut off from the power supply. A predefined list can be hard wired or be provided within the main memory which defines which peripherals should stay operative and which can be shut off.

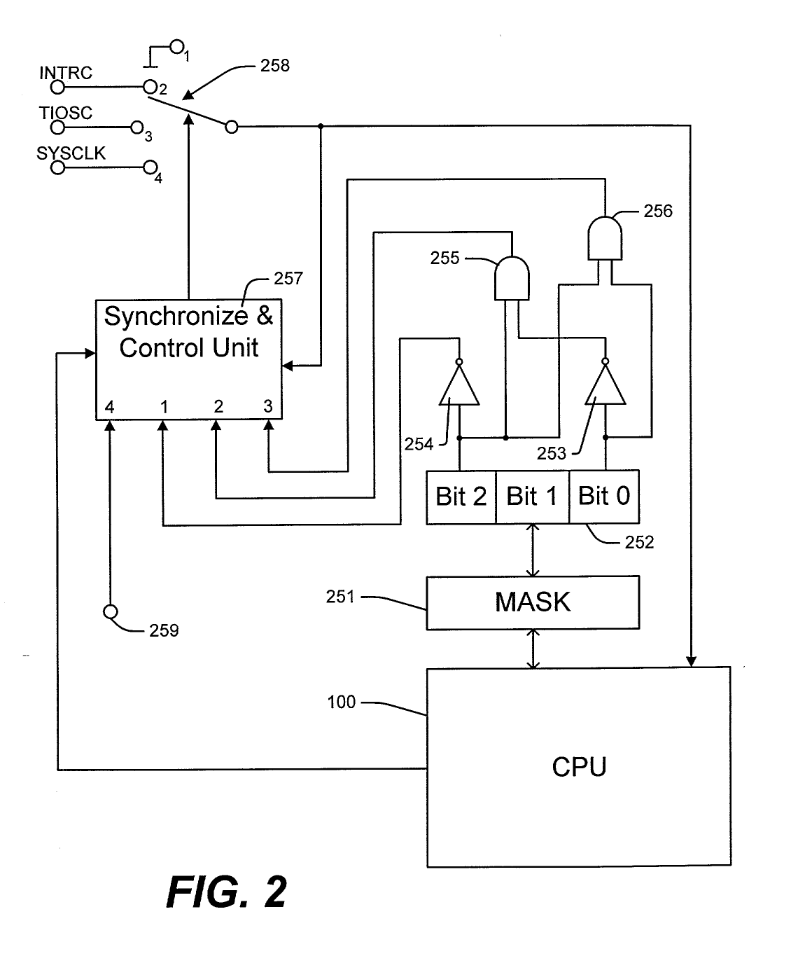

Turning to FIG. 2, in which same numerals denote similar elements, central processing unit 100 is coupled through data and control lines with a mask register 251. Mask register 251 is coupled with a low power mode register 252 which in this exemplary embodiment comprises three bits. Bit 0 of low power mode register 252 is coupled with the input of a first inverter 253 and with the first input of an AND gate 256. Bit 2 of low power mode register 252 is coupled with the input of a second inverter 254, the first input of another AND gate 255 and the second input of AND gate 256. The output of the first inverter 253 is coupled with the second input of AND gate 255. A synchronizer and control unit 257 is provided which receives a plurality of input signals and generates an output signal which controls a select switch 258. Select switch 258 can be put in four different positions 1, 2, 3, and 4 by synchronizer and control unit 257. A first position couples the select terminal of select switch 258 with ground, a second position selects the internal RC-oscillator signal, a third position couples the output signal of divider unit 180, and a fourth position couples the system clock with the select terminal of select switch 258. The select terminal of select switch 258 is coupled with the clock input terminal of central processing unit 100 and a synchronizer input of synchronized and control unit 157. A control input 4 of synchronizer and control unit 257 is coupled with a terminal 259. A control input 1 is coupled with the output of inverter 254. Control input 2 of synchronizer and control unit 257 is connected to the output of AND gate 255 and control input 3 is coupled with the output of AND gate 256. Central processing unit 100 generates a control signal which is sent to synchronizer and control unit 257.

The microcontroller according to the present exemplary embodiment switches into a low power mode by means of a special instruction, such as the sleep command. To select different low power modes a special register 252 is provided. Mask register 251 is optional and provides additional functionality to the microcontroller, as will be explained below. Register 252 is a special function register which can be part of another special function register, for example, a special function register which has three unused bits. The three bits of special function register 252 can theoretically provide eight different types of low power modes. In this exemplary embodiment according to the present application only six different low power modes are used. The system can of course be expanded to more modes or limited to less modes as will be readily understood by a person skilled in the art. As mentioned above, mask register 251 can provide additional security to allow central processing unit 100 setting or clearing only specific bits as indicated by this mask register 251. For example, only if a bit is set in mask register 251 then the respective bit in low power mode register can be altered. In another embodiment, mask register 251 determines a priority level. Low power mode register then contains the current priority and can only be changed to a lower priority.

As indicated above, only a single command is used to invoke a low power mode. The type of low power mode is defined by register 252 which can be set accordingly by a respective instruction within a program sequence. The different low power modes will be explained later in combination with the selection of different clock signals for the peripheral units.

FIG. 3A shows an exemplary embodiment of a select circuitry for selecting a clock signal for the peripheral units. Again, same numerals refer to similar elements. Central processing unit 100 is coupled with mode register 252 through mask register 251 as described with respect to FIG. 2. Bit 0 of mode register 252 is coupled with the first input of a 2:4 multiplexer 310. The second input of multiplexer 310 is coupled with bit 1 of mode register 252. Multiplexer 310 de-multiplexes the two bit input signal into four separate output signals which are fed to a synchronizer and control unit 320. Synchronizer and control unit 320 is controlled by central processing unit 100 and receives the output signal of a clock select switch 330 for synchronizing purposes. Clock select switch 330 has four positions 0, 1, 2, and 3, wherein in position 0 the ground signal is selected, in position 1 the system clock signal is selected, in position 2 the clock signal from internal RC-oscillator unit and in position 3 the output signal from divider unit 180 is selected.

Table 1 shows the different low power modes of the microcontroller according to the exemplary embodiment. Furthermore, the different clock signals provided for the central processing unit and for the peripheral units are depicted. Finally, Table 1 shows the different positions of select switch 258 and select switch 330 or the selected inputs of multiplexer 450 and the switch position of switch 495 with regard to the different low power modes. The bottom line of Table 1 shows the normal operation mode in which the low power mode register 152 has no effect.

TABLE 1

| | | | | Switch | Switch |
|---|---|---|---|---|---|
| Mode | Register 252 | CPU | Periperals | 258 | 330 |
| IDLE | 001 | off | SYS | 1 | 1 |
| DOZE | 010 | off | INTRC | 1 | 2 |
| NAP | 110 | INTRC | INTRC | 2 | 2 |
| SNOOZE | 011 | off | T1OSC | 1 | 3 |
| CATNAP | 111 | T1OSC | 3 | 3 | |
| SLEEP | 000 | off | off | 1 | 0 |
| Normal | — | SYS | SYS | 4 | 1 |

In the normal operating mode central processing unit as well as all peripheral units receive the system clock 153. To this end, input 4 of synchronizer and control unit 257 and input 321 of synchronizer and control unit 320 both receive signal 259, for example from a reset unit or from watchdog timer 105, which overrides all other inputs of synchronizer control units 257 and 320 and selects the system clock 153 as output signal which is fed to the central processing unit 100 and all peripheral units 120 . . . 130, and 110.

In case central processing unit 100 executes a sleep instruction a control signal is sent or initiated by the execution unit 101 to synchronizer and control units 257 and 320. According to the status of the mode register 252 select switch 258 and 330 will select different input signals. For example, if register 252 contains 001, the output of inverter 254 will be a logical “1” and the outputs of AND gates 255 and 256 will turn to “0”. Thus, synchronizer and control unit 257 will select switch position 1 which will turn off the system clock for central processing unit 100. At the same time the multiplexer 310 will de-multiplex bit 0 and bit 1 of mode register 252 which selects position 1 for select switch 330. Thus, the system clock will be selected as clock signal for all peripheral units 120 . . . 130. This mode is called IDLE and useful for any low power mode which does not need any support by the central processing unit, for example a pulse width modulator which is programmed by the central processing unit operates independently and controls an external device. During a low power mode operation of the modulator might be still necessary but the central processing unit could be shut down. The IDLE mode suits this special case by shutting down the central processing unit 100 and keeping up all operations by the peripherals.

A second low power mode is called DOZE mode and is represented by the value 010 for register 252. In this mode, central processing unit also does not receive a clock signal as select switch 258 is in position 1. Bit zero and bit one of register 252 are now de-multiplexed by multiplexer 310 into switch position 2 for select switch 330. Thus, the output signal of internal RC-oscillator unit 170 is selected as the clock signal for the peripheral units 120 . . . 130. A third low power mode is called NAP mode. In this mode, bit 2 of register 252 is high and bit 0 of register 252 is low, thus turning output of AND gate 255 high and selecting switch position 2 for select switch 258. Demultiplexer 310 receive 10 from bit 1 and bit 0 of register 252 and select position 2 for select switch 330. Thus, the output of internal RC-oscillator unit 170 is selected for both the central processing unit and the peripheral unit 120 . . . 130. This mode is specifically useful in applications where both the central processing unit and the peripheral need to operate but can run with a slower clock.

A fourth low power mode is called SNOOZE mode. This mode is indicated by the value 011 of register 252. As bit 2 of register 252 is “0”, the clock supplied for the central processing unit 100 is again shut off. Switch 330 is controlled to select switch position 3, thus selecting the output of divider unit 180.

The following low power mode is called CATNAP mode. In this mode both the central processing unit 100 and the peripheral units 120 . . . 130 receive the same clock signal, namely the output of divider unit 180 as select switch 258 is turned into position 3 and select switch 330 is turned into position 3. The low power mode which preserves most energy is called the SLEEP mode and reflected by register 252 having a content of 000. In this mode, select switch 258 is turned to position 1 and select switch 330 is turned to position 0, thus cutting off the supply of any clock signal by coupling the respective inputs of ground.

The switching process from one clock signal to another clock signal might need synchronization to prevent an undefined status for the central processing unit. To this end, FIG. 3B shows a suitable circuitry to synchronize the switching. A NAND gate 640 and an AND gate 650 are provided for synchronizing unit 600. A first input 620 of NAND gate 640 receives the output signal of switch 258 or 330 and a second input receives the clock signal which is to be selected. The output of NAND gate 640 is coupled with the first input of AND gate 650 whose second input 610 receives the switching control signal from the decoder circuitry. Thus, switching can only take place when bot clocks, the current and the new selected one, are both at a logical “0” and will be therefore synchronized.

The embodiment shown in FIG. 1 can be easily modified to set different clock signals for the CPU and the peripherals. Table 1 shows only some selected modes. Other modes are possible, inparticular modes in which the peripherals receive the normal system clock and the CPU a slower clock or scenarios in which the setting is vice cersa.

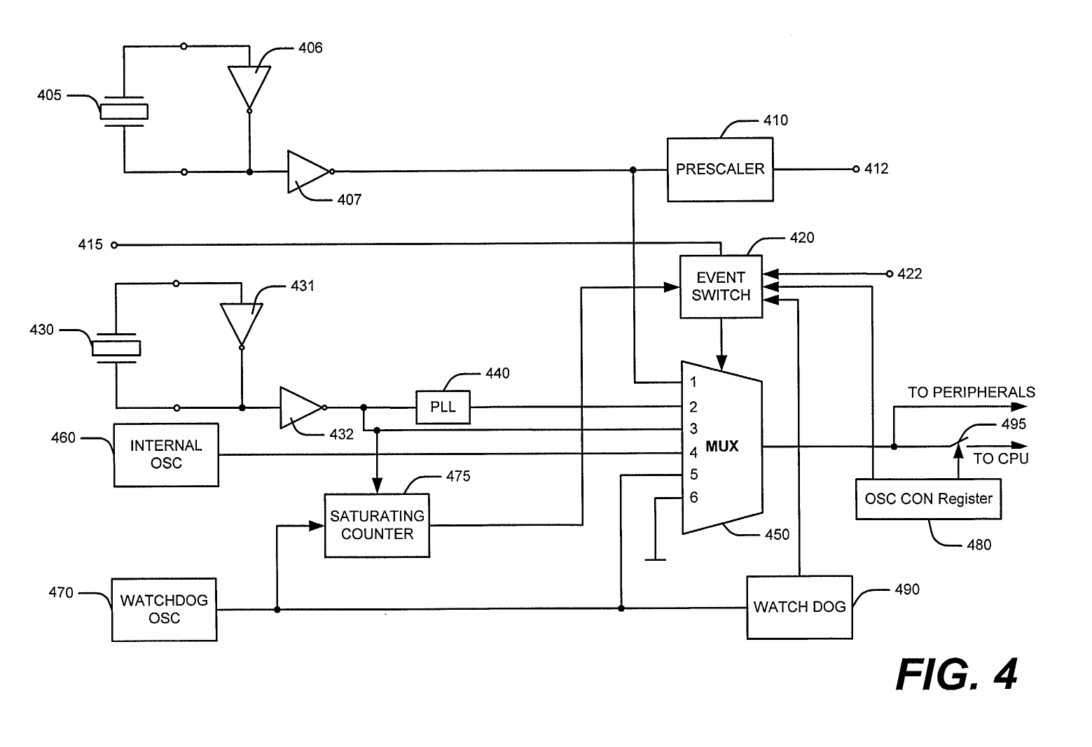

FIG. 4 shows another exemplary embodiment according to the present invention. A first oscillator unit comprises an external crystal 405 coupled with two terminals. A first internal inverter 406 is coupled to these terminals. The output of inverter 406 is connected to the input of a second inverter 407 whose output carries a first clock signal which is fed to a prescaler 410 for further distribution through terminal 412 and the first input of a multiplexer 450. A second oscillator is formed by another external crystal 430 and two inverters 431 and 432 coupled with the crystal 430 in the same way as described above. The output of inverter 432 carries therefore the second clock signal which is fed to the input of a PLL circuit 440 whose output is coupled with the second input of multiplexer 450. Furthermore, the output of inverter 432 is connected with the third input of multiplexer 450. An internal RC-oscillator is designated by numeral 460 and provides a fourth clock signal which is fed to the fourth input of multiplexer 450. Furthermore, an internal watchdog oscillator 470 is provided which provides a fifth clock signal for the watchdog unit 490 and the fifth input of multiplexer 450. A ground signal is fed to the sixth input of multiplexer 450. the output of multiplexer 450 is coupled with the clock inputs of all peripherals that need a clock signal and to the first terminal of a controllable switch 495 whose other terminal is coupled with the clock input terminal of the CPU. A event switch unit 420 is provided which controls multiplexer 450 and receives control signals from an external terminal 415, an internal terminal 422 and from watchdog timer 490. Multiplexer 450 is also controlled by oscillator control register 480 (OSCCON). One bit within the OSCON register 480 furthermore controls event switch unit 420. A saturating counter 475 comprises a clock input which is coupled with the output of watchdog oscillator 470. A reset input for saturating counter is coupled with the output of inverter 432 and the output of saturating counter is coupled with the event switch unit 420.

This embodiment provides versatile clock distribution with the possibility of having different settings for CPU and the peripheral units thereby providing a minimum of necessary hardware and thus a minimum of silicon real estate requirements. Basically, multiplexer 450 selects one of a plurality of clock signals and either sends the selected signal to both, the CPU and the peripheral units or only to the peripheral units, whereby the CPU receives no clock signal and is shut down. The second oscillator 430, 431, 432 provides the normal system clock, whereby one or more bits within OSCON register 480 can control settings of the PLL circuit. In another embodiment a second multiplexer can be used to select between the two normal system clocks by means of another bit within OSCON register 480. However, in the shown embodiment both system clock signals (second and third clock signals) are fed to multiplexer 450. The internal oscillators 460 and 470 can RC oscillators with or without a PLL circuit. The saturation counter 475 is used to monitor proper system clock operation. To this end, this counter counts for 8 clock transitions. Any transition of the system clock resets the counter 475. Thus, if the external crystal breaks, the saturation counter will not be reset and triggers a switch to an internal clock source through event switch unit 420. Furthermore a flag will be set to indicate that the system clock source failed.

For the embodiment of FIG. 4, generally two types of low power modes are provided as can be seen in Table 2.

TABLE 2

| Mode | Register | CPU | Peripherals | MUX 450 | Switch 495 |
|---|---|---|---|---|---|
| Sleep Mode 0 SLEEP | 000 | off | off | 6 | open |
| Sleep Mode 1 DOZE | 010 | 1st clock | 1st clock | 1 | closed |
| Sleep Mode 2 SNOOZE | 011 | 4th, 5th clock | 4th, 5th clock | 4/5 | closed |
| Idle Mode 0 IDLE | 001 | off | 2nd, 3rd | 2/3 | open |
| | | | clock | | |
| Idle Mode 1 CATNAP | 111 | off | 1st clock | 1 | open |
| Idle Mode 2 NAP | 110 | off | 4th, 5th clock | 4/5 | open |
| Normal | — | 2nd, 3rd clock | 2nd, 3rd | 2/3 | closed |
| | | | clock | | |

The idle modes in which the CPU is shut down and the sleep modes in which both the peripherals and the CPU receive the same clock signals.

During the SLEEP mode, the CPU and the peripherals are deactivated as switch 495 is controlled to be open and multiplexer 450 is controlled to switch to the sixth input signal which is ground. This also shuts down a Flash/Eprom bias circuits and any other high current core circuits because the program memory array is not in use. This mode can be exited on any reset or on an interrupt through terminal 415 if the corresponding interrupt enable bit is set.

In the DOZE mode, the default oscillator source is turned off to save power on the following cycle. Switching from the current clock to the first oscillators can be synchronized by waiting for a certain number of clock transitions, for example, eight cycles. The first oscillator 405, 406,407 is used to provide clock signals to both the peripherals and the CPU. The bias circuits for the Flash/Eprom arrays are configured in a low power mode which will in turn lengthen the access time. This is not a problem because the system clock is derived from the first oscillator which is usually providing a very slow clock signal, such as 32 kHz. DOZE mode can be exited on any reset or on an interrupt through terminal 415 if the corresponding interrupt enable bit is set.

In the SNOOZE mode, the system clock will be switched from the second or third clock signal to one of the internal oscillators. The default oscillator source is turned off to save power on the following cycle. Switching from the current clock to the internal oscillators 460 or 470 can be synchronized by waiting for a certain number of clock transitions, for example, eight cycles. The third or fourth oscillator 460, 470 is used to provide clock signals to both the peripherals and the CPU. SNOOZE mode can be exited on any reset or on an interrupt through terminal 415 if the corresponding interrupt enable bit is set.

During the IDLE mode multiplexer 450 selects clock signal 2 or 3 depending on a bit within OSCON register 490. Switch 495 is open annd therefore no clock signal is fed to the CPU. this mode is the only low-power mode that does not disable the system clock. When the device enters the IDLE mode, the core will be disabled. This can also shut down a Flash/Eprom bias circuits and any other high current core circuits because the program memory array is not in use. This mode can be exited on any reset or on an interrupt through terminal 415 if the corresponding interrupt enable bit is set.

During the CATNAP mode, the CPU is deactivated as switch 495 is controlled to be open. Again, this can also shut down a Flash/Eprom bias circuits and any other high current core circuits because the program memory array is not in use. All peripherals receive the clock signal from the first oscillator unit 405, 406, 407. This mode can be exited on any reset or on an interrupt through terminal 415 if the corresponding interrupt enable bit is set.

During the NAP mode, the CPU is deactivated as switch 495 is controlled to be open. Again, this can also shut down Flash/Eprom bias circuits and any other high current core circuits because the program memory array is not in use. All peripherals receive the clock signal from either oscillator 460 or 470 depending on the setting in OSCON register 480. This mode can be exited on any reset or on an interrupt through terminal 415 if the corresponding interrupt enable bit is set.

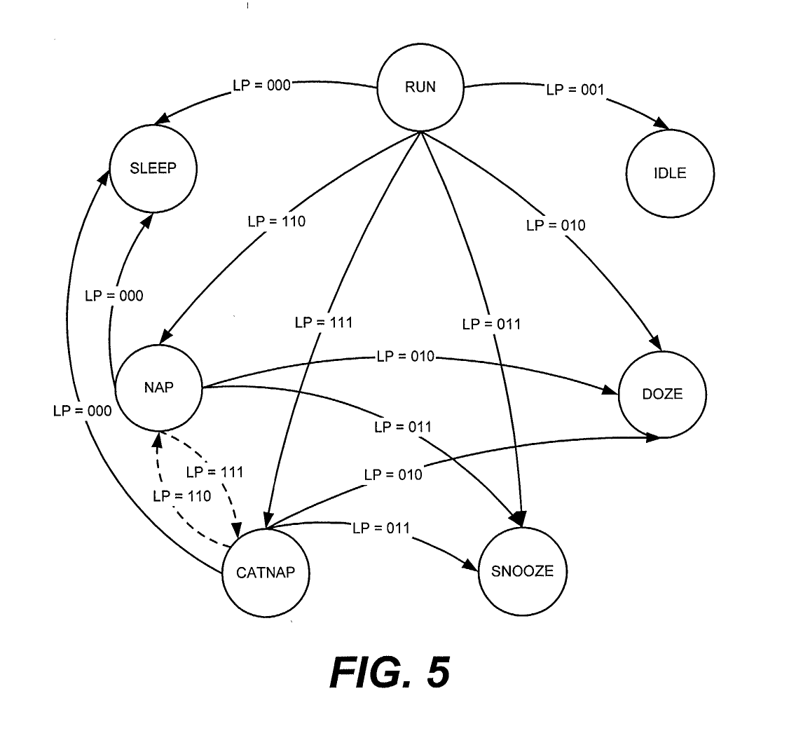

FIG. 5 shows a state diagram which reflects the different switching possibilities from different low power modes. Normal operating mode in this Figure is designated as “RUN”. From this state the microcontroller can transfer into anyone of the six different low power modes by setting the low power mode register to the respective value and executing a sleep instruction. Whenever the central processing unit 100 is turned off by selection of the ground signal as a system clock signal, no further transition can take place as the central processing unit 100 cannot execute any instruction. Thus only a reset or a wake-up signal, for example, from watchdog timer 105 can restart the central processing unit 100.

Two low power modes allow further transition to other low power modes. The NAP mode allows a transition to the SLEEP, DOZE and SNOOZE mode. Modes CATNAP and IDLE are not selectable in this embodiment. However, it is generally possible to implement an embodiment which allows selection of those which is indicated by the dotted line with respect to the NAP and CATNAP mode. The embodiment shown in FIG. 4 does not include modes in which a switch from a lower power mode to a higher power mode is possible.

Mask register 251 can be used in another embodiment to limit the modes to which the system can switch. To this end mask register can contain a priority value. The different modes are assigned to different priority levels starting from the lowest to the highest. Whenever a low power mode is entered, the mask register can be automatically set to the respective priority level. thus, only higher prioritized low power modes can be set by the system until a reset or wake-up signal has been generated.

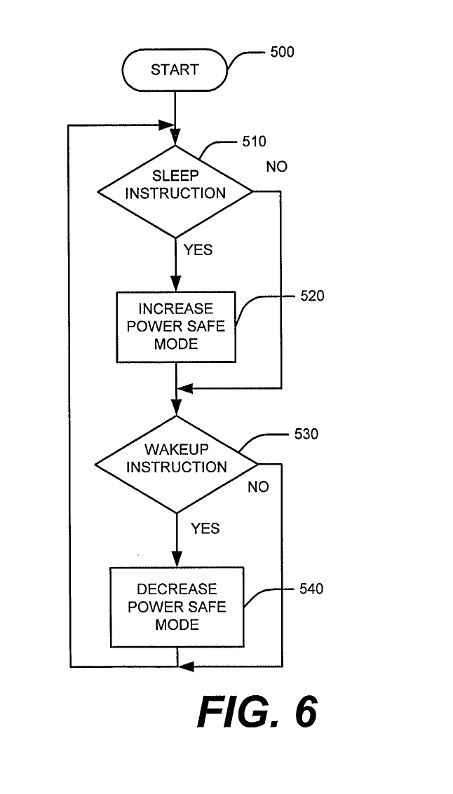

FIG. 6 shows yet another exemplary embodiment in which the register is initially set to the highest priority level. In this embodiment the central processing unit does not have to set new values for low power mode register 252 as the system steps through a predefined sequence of low power modes. This sequence can be stored, for example, in memory unit 110. Low power mode register can be used as an indirect addressing register which points to offset values added to a table pointer. Table 3 shows an exemplary sequence of different low power modes.

TABLE 3

| LOW POWER MODE | CPU | Peripherals |
|---|---|---|
| 111 | SYS | SYS |
| 110 | T1OSC | SYS |
| 101 | T1OSC | T1OSC |
| 100 | INTRC | T1OSC |
| 011 | INTRC | T1OSC |
| 010 | INTRC | off |
| 001 | off | off |

The system starts in normal mode represented by value 111 in low power mode register 252 in step 500. However register 252 is preset to 110 which represents the next low power level into which the system will enter after execution of a sleep instruction. This value is the default value which is set after a reset or a wake-up signal from watchdog timer 105. Step 510 checks whether a sleep instruction has been executed. If yes, then in step 520 the clock signals are set according to the value of low power mode register 252. Then, the value of the low power mode register is decremented by 1. If no, the sequence skips step 520 and proceeds with step 530 where the execution of a wakeup instruction is monitored. This instruction is complementary to the sleep instruction and allows a reverse function which increases the speed and power consumption of the system. If a wakeup instruction has been executed the system first increases the content of low power register and then sets the clock signals according to the content of low power register 252. In case all clocks are shut off as in low power mode 001 of course only a reset or wake-up signal can reactivate the central processing unit 100. As the system accesses the table through register 252 any change to the sequence can be made during program execution. Register 252 can be implemented as a counter to perform the above task.

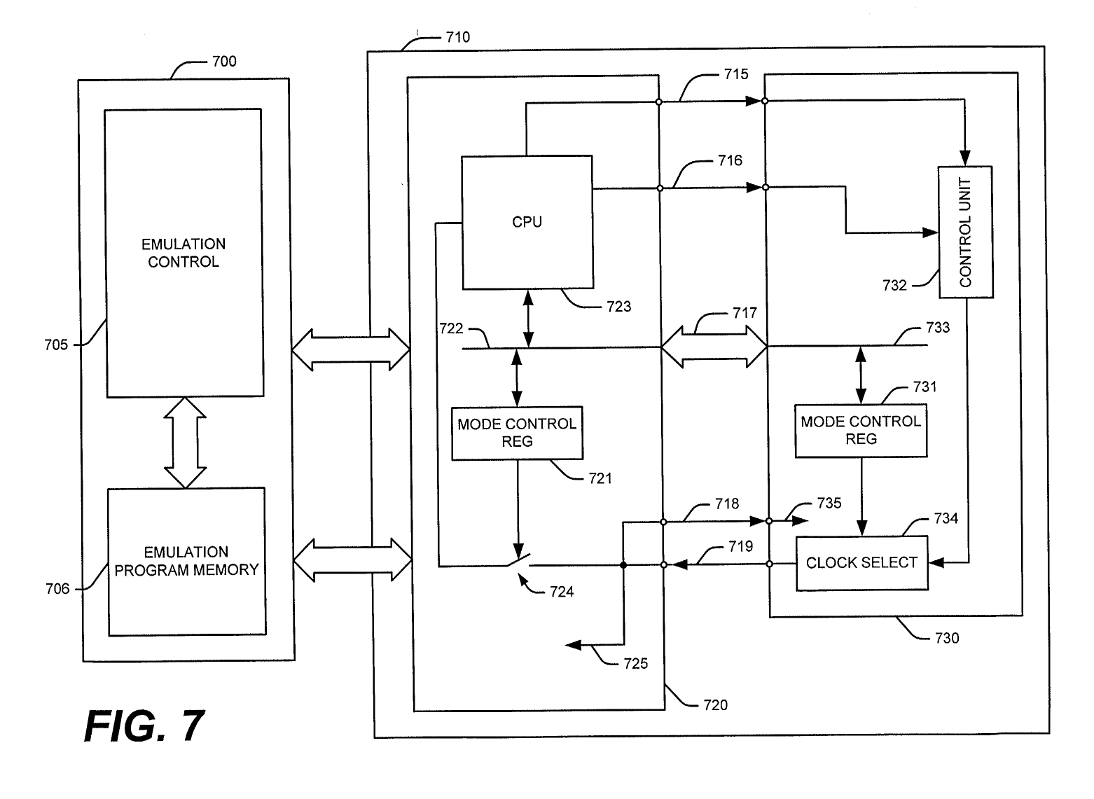

FIG. 7 depicts another exemplary embodiment showing an emulator arrangement. Emulators are used to test and debug new or existing microprocessor based applications. Usually a microprocessor or microcontroller in an application is removed and replaced by an emulator header board. The header board generally comprises a bond-out chip version of the respective microcontroller or microprocessor. The emulator proper is able to monitor all relevant signals and trace program sequences with a plurality of options, such as setting breakpoints, break conditions, single or multiple step operation, etc. In particular, real-time operation and monitoring is possible with an emulator. Furthermore, an emulator can be easily adapted to a plurality of different versions of a microcontroller having different peripherals, memories, performance characteristics, etc. To this end, an emulator arrangement as shown in FIG. 7 comprises an emulator unit 700 including an emulator control unit 705 coupled with an emulator program memory 706. An emulator header board 710 is coupled with the emulator unit 700 through one or multiple busses. The emulator header board 710 comprises a master chip 720, for example a bond-out version of a microcontroller type. Generally, microcontrollers of a single type are available in many different versions comprising a variety of different peripherals. Therefore, a unique bond-out chip version of this family is used whereby usually no or only a minimum of peripherals are present. The bond-out chip 720 comprises connection pins to internal signals which are normally not accessible on a standard microcontroller to allow access and monitor capabilities for the emulator unit 700.

A second slave chip 730 is coupled with the master chip 720. The slave chip 730 is a version of the microcontroller to be emulated, whereby the central processing unit is deactivated. The slave chip 730 is coupled with the master chip 720 in a way, that all peripherals on the slave chip can be accessed and controlled by the master chip. FIG. 7 shows exemplary some of these connections. Both chips comprises, for example, an internal data bus 722 and 733, respectively. These busses 722 and 733 are coupled through bus 717. Central processing unit 723 of master chip 720 is connected to data bus 722. Low power mode register 721 of the master chip is also coupled with the central processing unit 723 through data bus 722. Clock select circuitry 724 is coupled with low power mode register 721 and central processing unit 723. Central processing unit 723 generates a sleep control signal 715 which is fed to a control unit 732 of slave chip 730. Furthermore, central processing unit 723 generates a reset control signal 716 which is also fed to control unit 732. Control unit 732 generates a control signal for a clock select unit 734 on slave chip 730 which is coupled with mode control register 731. The output signal 719 of clock select unit 734 is fed to master chip 720 where it is fed to the clock input of central processing unit 723 through a controllable switch 724. Controllable switch is controlled by mode control register 721. Furthermore, clock signal 719 is fed to any peripherals on board of master chip 720 as internal peripheral clock signal 725. Clock signal 719 is also returned to a clock input of slave chip 730 through signal line 718 from where it is distributed to the peripheral units as a peripheral clock signal 735 on slave chip 730.

Emulating the low power modes as described above in this emulator environment causes several problems. The slave unit has its own low power mode register 731 with respective clock select circuitry 734 but no active central processing unit to control the respective mode register. Clock select circuitry 734 receives a respective control signal by control unit 732. Central processing unit 723 generates a sleep indicator signal 715 which is usually used to signal external components to go into a low power mode. According to this embodiment this signal is used to indicate to control unit 732 that a low power mode will be entered. Central processing unit 723 reads and writes low power mode register 721. Mode control register 731 on the slave chip is coupled through busses 733, 717, abd 722 with central processing unit 723 and mapped to the same address. Thus, any writing to mode control register 721 also affects mode control register 731 at the same time After a sleep instruction is executed, control unit 732 activates the clock select circuitry 734 to select the respective clock signals. Control unit 732 can comprise the respective circuitry to generate the appropriate timing for those control signals. The selected clock signal is fed to the master chip 720. Master chip 720 comprises a controllable switch 724 which decides whether the clock signal will be fed to central processing unit or whether central processing unit 723 will be shut down. The clock signal is also distributed to all peripheral units as peripheral clock signal 725, as far as they are implemented on the master chip 720. Any other possible manipulation of the clock signal (not shown in FIG. 7) takes place on the master chip. The clock signal is then fed back to the clock input of slave chip 730 from where it is distributed to all peripheral units of the slave chip 730 as peripheral clock signal 735. Thus, central processing unit 723 generates pulses on 715 which select the clock supply signals on the slave chip 730 and distribute the clock signal on the master chip 720. Master chip 720 can also generate a reset signal 716. This signal can be generated by the central processing unit 723 or other appropriate units on the chip. This reset signal 716 is also fed to control unit 732 which then resets low power mode register to its default value and also controls the clock select circuitry 734 to its respective default values such as the system clock.

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A microprocessor comprising:
a central processing unit receiving a first clock signal;
a plurality of peripherals receiving a second clock signal;
a first select unit for selecting said first clock signal out of a plurality of clock signals;
a second select unit for selecting said second clock signal out of said plurality of clock signals;
an execution unit within said central processing unit which controls said select units upon execution of a low power mode instruction.

2. Microprocessor according to claim 1, further comprising a low power mode register for determination of a low power mode being coupled with said select units.

3. Microprocessor according to claim 2, further comprising a mask register coupled with said low power mode register for limiting access to said low power mode register.

4. Microprocessor according to claim 2, further comprising a multiplexer coupled with said low power mode register for controlling a select switch control unit controlling a select switch receiving said plurality of clock signals.

5. Microprocessor according to claim 4, further comprising a synchronizer unit for synchronizing switching of said clock signals.

6. Microprocessor according to claim 1, wherein said first select unit is a switch receiving said second clock signal.

7. Microprocessor according to claim 1, wherein one of said clock signals is generated by an oscillator unit.

8. Microprocessor according to claim 1, wherein one of said clock signals is generated by a low power oscillator unit.

9. Microprocessor according to claim 1, wherein one of said clock signals is generated by an internal oscillator.

10. Microprocessor according to claim 7, further comprising a divider unit coupled between said oscillator unit and said select unit.

11. Microprocessor according to claim 1, further comprising a watchdog timer which generates a control signal fed to said select units for setting a default clock.

12. A microprocessor comprising:
a central processing unit having a clock input;
a plurality of peripherals having clock inputs;
a first select unit for selecting a clock signal out of a plurality of clock signals, said selected clock signal being fed to said clock inputs of said peripheral units;
a controllable switch for coupling said selected clock signal with said clock input of said central processing unit;
an execution unit within said central processing unit which controls said select unit and said switch upon execution of a low power mode instruction.

13. Microprocessor according to claim 12, further comprising a low power mode register for determination of a low power mode being coupled with said select unit and said switch.

14. Microprocessor according to claim 12, wherein said select unit is a multiplexer.

15. Microprocessor according to claim 12, wherein one of said clock signals is generated by an oscillator unit.

16. Microprocessor according to claim 12, wherein one of said clock signals is generated by a low power oscillator unit.

17. Microprocessor according to claim 12, wherein one of said clock signals is generated by an internal oscillator.

18. Microprocessor according to claim 12, further comprising an internal watchdog oscillator generating one of said clock signals.

19. Microprocessor according to claim 18, further comprising a saturating counter having a count input and a reset input and an output, said reset input being coupled with one of said plurality of clock signals, said count input being coupled with said watch dog oscillator, and said output being coupled with said select unit.

20. A microprocessor emulation unit comprising:
a first microprocessor comprising:
a central processing unit having a clock input and generating a low power mode signal upon execution of a low power instruction;
a controllable switch coupled with said clock input;
a first register coupled with said switch for storing a low power mode value;
an execution unit within said central processing unit which controls said switch upon execution of a low power mode instruction,
a second microprocessor comprising:
a plurality of peripherals units having a clock input;
a select unit for selecting a system clock signal out of said plurality of clock signals wherin said selected clock signal is fed to said controllable switch and said clock inputs of said peripheral units;
a second register coupled with said select unit for storing a low power mode value wherein said second register is coupled with said first register through a bus.

21. Microprocessor emulation unit according to claim 20, wherein said first microprocessor generates a reset signal which is fed to said control unit for selection of a default clock value.

22. Method of setting clock signals for a central processing unit and at least one peripheral unit within a microcontroller arrangement, comprising the steps of:
selecting a low power mode;
selecting a clock value;
executing a low power instruction;
depending on said low power mode:
coupling or decoupling said clock signal with said central processing unit; and
coupling said clock signal with said peripheral unit.

23. Method according to claim 22, further comprising the steps of:
storing a value associated with said low power mode in a low power mode register;
controlling a first and second switch according to the content of said register to select said clock signal for said central processing unit and said peripheral unit, respectively.

24. Method according to claim 22, wherein clock values are selected out of a plurality of clock signals provided by a plurality of oscillator units.

25. Method of setting clock signals for a central processing unit and at least one peripheral unit within a microcontroller arrangement, comprising the steps of:
selecting a first and second clock value;
executing a low power instruction;
coupling said first clock signal with said central processing unit; and
coupling said second clock signal with said peripheral unit.

26. Method according to claim 25, further comprising the steps of:
storing a value associated with a low power mode in a low power mode register;
controlling a first and second switch according to the content of said register to select said first and second clock signal, respectively.

27. Method according to claim 25, wherein clock values are selected out of a plurality of clock signals provided by a plurality of oscillator units.

28. Method according to claim 25, wherein clock values are selected out of a plurality of clock signals provided by a divider unit coupled with an oscillator.

29. Method according to claim 25, further comprising the step of storing a mask value for allowing only predefined values for said low power mode register.

30. Method according to claim 29, wherein said mask value is a priority level and only lower priority values are allowed for said low power mode register.

31. Method according to claim 25, wherein said coupling is synchronized with said selected clock values.

32. Method according to claim 25, further comprising the steps of:
providing a list of peripheral units associated with said low power mode list indicating whether a peripheral unit will be turned off within a respective low power mode;
upon selection of a low power mode turning off those peripheral units which are marked in said list.

33. Method of emulating a microcontroller having a plurality of low power modes, comprising the steps of:
providing a microprocessor having a first low power mode register;
providing a microcontroller having a second low power mode register;
deactivating a central processing unit of said microcontroller and coupling said microprocessor and said microcontroller to form a single microcontroller;
mapping said low power mode registers to the same address;
selecting a clock signal within said microcontroller according to said low power mode register content and transferring said clock signal to said microprocessor;
coupling or decoupling said clock signal with said microprocessor according to said first low power mode register content.

34. Method according to claim 33, wherein said transfer is initiated by a low power mode control signal.

35. Method of initiating different low power modes within a microcontroller, comprising the steps of:
predefining a priority list of low power modes defining clock signals for a central processing unit and for at least one peripheral unit;
setting a priority level within said list;
upon execution of a first low power mode instruction selecting said clock signals according to the selected list entry and selecting the next list entry.

36. Method according to claim 35 further comprising the step of:
upon execution of a second low power mode instruction selecting a previous list entry and accordingly selecting said clock signals.

37. Method according to claim 35, wherein said list is addressed by indirect addressing through a register.

38. Method according to claim 37, wherein said register is a counter register and said selection is performed by incrementing or decrementing said counter value.
